(19) United States
(12) Patent Application Publication
(10) Pub. No.: US 2017/0352162 A1
(43) Pub. Date: Dec. 7, 2017

(54) REGION-OF-INTEREST EXTRACTION DEVICE AND REGION-OF-INTEREST EXTRACTION METHOD

(71) Applicant: OMRON Corporation, Kyoto-shi (JP)

(72) Inventors: Xiang RUAN, Otsu-shi (JP); Naru YASUDA, Uji-shi (JP); Yanping LU, Otsu-shi (JP); Huchuan LU, Dalian-city (CN)

(73) Assignee: OMRON Corporation, Kyoto-shi (JP)

(21) Appl. No.: 15/683,997

(22) Filed: Aug. 23, 2017

Related U.S. Application Data
(63) Continuation of application No. PCT/JP2016/050344, filed on Jan. 7, 2016.

(30) Foreign Application Priority Data
Mar. 5, 2015 (CN) 201510098283.2

(51) Int. Cl. G06T 7/60; G06F 17/30

(52) U.S. Cl. CPC G06T 7/60; G06F 17/30247; G06T 2207/20076

(57) ABSTRACT

A region-of-interest extraction device is provided with an extraction unit configured to extract one or a plurality of local regions from an input image; a retrieval unit configured to search an image database storing a plurality of images and retrieve an image matching a local region for each of the local regions extracted by the extraction unit; and a relevance score determination unit configured to determine a relevance score for each of the local regions on the basis of the retrieval result from the retrieval unit.

### CROSS REFERENCE TO RELATED APPLICATIONS

This application is a continuation application of International Application No. PCT/JP2016/050344, filed on Jan. 7, 2016, which claims priority based on the Article 8 of Patent Cooperation Treaty from prior Chinese Patent Application No. 201510098283.2, filed on Mar. 5, 2015, the entire contents of which are incorporated herein by reference.

### FIELD

The disclosure relates to extracting a region of interest from an image.

### BACKGROUND

Various techniques are available for detecting (extracting) regions of interest within an image. A region of interest is an image region that a person is likely to or should focus their attention. Region-of-interest detection is also sometimes referred to as saliency detection, objectness detection, foreground detection, attention detection, or the like. The algorithms for these techniques can be largely divided into two approaches: learning-based or model-based.

Learning-based algorithms learn the pattern of the region for detection on the basis of a large quantity of image data pertaining to the learning target. For instance, Patent Document 1 describes learning and selecting a type of feature in advance on the basis of a plurality of image data of the learning target; features are extracted from each portion of the image data being processed on the basis of the kind of feature selected and the saliency measure calculated for the image data being processed.

Model-based algorithms use a mathematical expression of the neural response that occurs when a person views an image (i.e., neural response model) to extract regions of interest from an image. For example, Non-Patent Document 1 models the information transmitted to the brain when light stimulates a region known as a receptive field that is found in a retinal ganglion cell of the eye. The receptive field is made up of what is known as a center region and a surround region. The model in Non-Patent Document 1 is constructed to digitize the locations of spikes (places drawing interest) in accordance with stimulus to the center and the surround.

### RELATED ART DOCUMENTS

### Patent Documents

Patent Document 1: Japanese Unexamined Patent Application Publication No. 2001-236508

### Non-Patent Documents

Non-Patent Document 1: Laurent Itti, Christof Koch, Ernst Niebur, “A Model of Saliency-based Visual Attention for Rapid Scene Analysis”, IEEE Transactions on Pattern Analysis and Machine Intelligence, Nov. 1998, Vol. 20. No. 11, pp. 1254-1259.

### SUMMARY

### Technical Problem

While learning-based algorithms do not require building a neural response model, the detection results therefrom do depend on the learning data. A learning-based algorithm cannot detect an object that is not similar to the learning data. In contrast, a model-based algorithm can detect a region of interest without prior knowledge; however, building a model is challenging, and the model-based algorithm for detecting regions of interest might not be sufficiently accurate. Consequently, neither of these approaches is able to accurately extract a region of interest without some limitation on the detection object.

Furthermore, neither approach is capable of determining which region is important when a plurality of regions is detected in a single image, and thus neither approach can determine which region would be of more interest. When multiple regions are detected, these regions should be ranked by their relevance.

One or more embodiments address the foregoing challenges by providing a method that allows accurate extraction of a region of interest from an image, and makes it possible to compute a relevance score therefor.

### Solution to Problem

One or more embodiments extract a local region from an input image, retrieve images similar to the local region from an image database, and obtain a relevance score for the above-mentioned local region using the retrieval result. It is thus possible to provide highly accurate extraction of a region of interest that reflects information pertaining to the images stored in an image database.

More specifically, a region-of-interest extraction device according to one or more embodiments is provided with an extraction unit configured to extract one or a plurality of local regions from an input image; a retrieval unit configured to search an image database storing a plurality of images and retrieve an image matching a local region for each of the local regions extracted by the extraction unit; and a relevance score determination unit configured to determine a relevance score for each of the local regions on the basis of the retrieval result from the retrieval unit.

It may be preferable that the above-mentioned local region is an image region in the input image estimated to be of interest to a person, or an image region that should potentially be given attention, i.e., a potential region of interest. The extraction unit may extract a local region using any existing method. The extraction unit may extract a local region through a region of interest extraction technique that uses a learning-based or a model-based algorithm.

The image database stores a plurality of image data in a manner that the image data can be retrieved. The image database may be integrally structured with the region-of-interest extraction device, or may be constructed as a separate device. For example, the image database may be a storage device provided with a region-of-interest extraction device. The image database may also constructed as a separate device accessible to the region-of-interest extraction device via a communication network. The creator or administrator of the image database need not be the same as the creator or administrator of the region-of-interest extraction device. A third-party image database publicly available via the Internet may serve as the image database used in one or more embodiments.

The retrieval unit searches the image database for images matching the local region extracted by the extraction unit to obtain the retrieval result. More specifically, the retrieval unit creates an inquiry (query) that requests images matching the local region, transmits the query to the image database, and acquires the response to the query from the image database. Searching for and retrieving similar images from the image database can be carried out using any existing method. For instance, an algorithm that computes a similarity score on the basis of comparing entire images, comparing an entire image to a portion of an image, or comparing a portion of one image, with a portion of another image may be used to retrieve a similarity score.

A relevance score determination unit determines a relevance score of a local region on the basis of a retrieval result from the retrieval unit for each of the local regions. A relevance score is a value indicating the level of interest a person is estimated to have in the local region, or the level of interest a person should have in the local region. A certain local region with a high relevance score indicates that a person is either greatly interested in that local region, or should be greatly interested in that local region. The relevance score may be determined in relation to humans in general, in relation to a certain group of people (people having a specific attribute), or in relation to a specific individual.

The relevance score determination unit may determine a relevance score of a local region using statistical information of an image retrieved by the retrieval unit as matching the local region (referred to below as simply a similar image). The statistical information is information that can be obtained through statistical processing of information obtained from the results of the search.

For instance, the number of images matching the local region may be adopted as statistical information, and the larger the number of similar images the larger the value of the relevance score determined. This is because the larger the number of objects (target region) stored in the database, the more likely that object is of interest. Note that the number of similar images could also conceivably indicate the reliability (accuracy) that a region extracted by the extraction device is a region of interest. Accordingly, because a local region returning a few similar images may be a false positive and not necessarily a region of interest, it may be preferable that the relevance score determination unit does not determine a relevance score for local regions where the number of similar images is below a given threshold.

The tag information associated with the similar image may also be adopted as statistical information. Here, tag information represents information stored in association with the image data in the image database, and which includes natural language to specify the content and attributes of the image data. This tag information may be encapsulated in the image data, or may be stored in a file separately from the image data. The tag information may be added in any desired manner, e.g., that that information may be manually input by a person, or automatically added by a computer through image processing. When the tag information is adopted as the statistical information, it may be preferable that the relevance score determination unit determines a higher relevance score for a local region the greater the semantic convergence of tag information associated with the image to similar images. This is because the greater the semantic convergence the more generally recognizable that region, and the greater the interest in that region. It may be preferable that semantic convergence is determined through natural language processing; for example, similar or neighboring concepts should be determined as being semantically close together even when the wording used in the tag information is different.

The mean, median, median, variance, standard deviation, or the like of a similarity score for an image matching the local region may be adopted as the statistical information. The relevance score may be determined as a greater value the greater the similarity score for a similar image, or the smaller the variance in similarity scores. In addition to the similarity score for a similar image, the size of the similar image (area or number of pixels), the location within the image, color or the like may be adopted as the statistical information. For example, the size of the similar image may be the size of the entire similar image the size of the region matching the local region (an absolute size or the size relative to the overall image size), may be adopted. Note that the position in the image may be the position of the region matching the local region in the entire image. The relevance score determination unit may determine the relevance score on the basis of the average, mean, mode, median, median, variance, or standard deviation or the like of this information.

The mean or the like of meta-information added to the similar image may also be adopted as the statistical information. Mentor information may include attribute information on the image itself (e.g., size, color space), and the imaging conditions (date taken, shutter speed, stop, ISO sensitivity measurement, metering mode, presence or absence of flash, focal length, imaging position or the like). The relevance score determination unit may determine the relevance score on the basis of this meta-information.

The relevance score determination unit may determine the relevance score for a local region on the basis of the size or location of the local region. The size of the local region may be an absolute size, or maybe the size in relation to the input image. The relevance score determination unit may determine the relevance score as a larger value the greater the size of the local region, or as a larger value the smaller the size of the local region. The relevance score determination unit may determine the relevance score as a larger value the closer the local region is to the center of the input image, or as a larger value the closer the local region is to the periphery of the input image. The relevance score determination unit may also take into account the type of object included in the local region in addition to the size or location of the local region when determining the relevance score.

The relevance score determination unit may obtain a plurality of relevance scores on the basis of the above-mentioned plurality of information, and determine a final relevance score that combines the plurality of relevance scores. The method of combining the plurality of relevance scores into a final relevance score is not particularly limited, and for example may be an integration of all the relevance scores or a weighted average thereof.

The region-of-interest extraction device according to one or more embodiments may further include a computation criteria acquisition unit configured to accept input of criteria for computing relevance score; the relevance score determination unit may computes the relevance score on the basis of a first relevance score computed according to a predetermined computation criteria, and a second relevance score computed according to a computation criteria acquired through the computation criteria acquisition unit. Here, the predetermined computation criteria may be a computation criteria for a relevance score targeting humans in general, and in other words is a general-purpose computation criteria. In contrast, the computation criteria obtained acquired through the computation criteria acquisition unit is situation specific; for instance, this computation criteria may depend on the user that will view the image, or may depend on the application that will use the region of interest extracted.

The region-of-interest extraction device according to one or more embodiments may also include an integration unit configured to combine a plurality of neighboring local regions included in the input image into a single local region. Neighboring local regions may be local regions that are adjacent, or may be local regions that are separated by a predetermined distance (number of pixels). The above-described predetermined distance may be determined in accordance with the size of the local region, the type of object included in the local region, or the like.

The region-of-interest extraction device according to one or more embodiments may also include an output unit configured to output the location of the local regions included in the input image and the relevance score for each of the local regions. The location of a local region may be output by, for instance superimposing a border on to the input image that shows the location of the local region, showing the local region with a different color or brightness than other regions. The relevance score may be outputs by showing a numerical value or showing a color or size marker in accordance with the relevance score. When outputting the location and relevance score of the local region, the output region may not display the relevance score or local regions when the relevance score thereof is less than a threshold, and show the position and relevance score of only the local regions with relevance score greater than or equal to a threshold.

Note that a region-of-interest extraction device including at least one portion of the above-mentioned units may be considered as one or more aspects. One or more aspects can also be considered a region-of-interest extraction method, or a relevance score computation method. Moreover, a program for executing the steps of these methods on a computer, or a computer readable medium temporarily storing such a program is also considered within the scope of the invention. The above-mentioned configurations and processes may be freely combined with each other insofar as is technically possible to configure the invention.

### Effects

A region-of-interest extraction device according to one or more embodiments makes it possible to extract a region of interest from an image and compute the relevance score therefor.

### BRIEF DESCRIPTION OF THE DRAWINGS

FIGS. 1A and 1B are block diagrams illustrating a hardware configuration of a region-of-interest extraction device according to a first embodiment, and the functions therein;

FIG. 2 is a flowchart illustrating the flow of processes for extracting a region of interest in a first embodiment;

FIG. 3A and 3B are diagrams illustrating examples of an input image and regions of interest extracted from the input image, respectively;

FIG. 4 is a diagram illustrating an overview of computing a relevance score for a region of interest;

FIG. 5A and FIG. 5B are diagrams illustrating the results of content-based image retrieval and computing a relevance score based on the retrieval result;

FIG. 6A and FIG. 6B are diagrams illustrating a flowchart representing the flow of processes, and an example outputting a relevance score respectively;

FIG. 7 is a flowchart illustrating the flow of processes for extracting a region of interest in a second embodiment;

FIG. 8 is block diagram illustrating the functions of a region-of-interest extraction device according to a third embodiment;

FIG. 9 is a flowchart illustrating the flow of processes for extracting a region of interest in a third embodiment;

FIG. 10 is block diagram illustrating the functions of a region-of-interest extraction device according to a fourth embodiment;

FIG. 11 is a flowchart illustrating the flow of processes for extracting a region of interest in a fourth embodiment; and

FIG. 12A and FIG. 12B are diagrams illustrating before and after a process to combine regions of interest respectively.

### DETAILED DESCRIPTION

### First Embodiment

A region-of-interest extraction device according to this embodiment searches within and retrieves a similar image from an image database to accurately extract regions of interest from an input image and compute the relevance score of each region of interest. The image database may be searched to acquire information that cannot be obtained from the input image thereby making it possible to extract a region of interest and compute the relevance score accurately.

Configuration

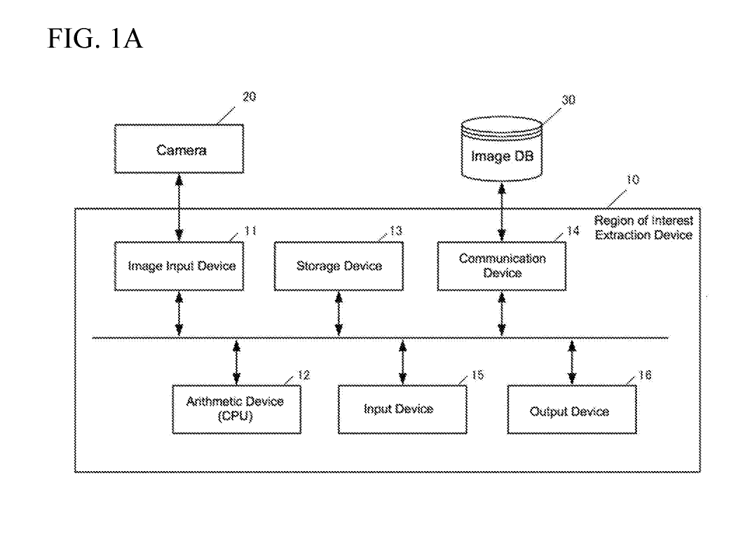

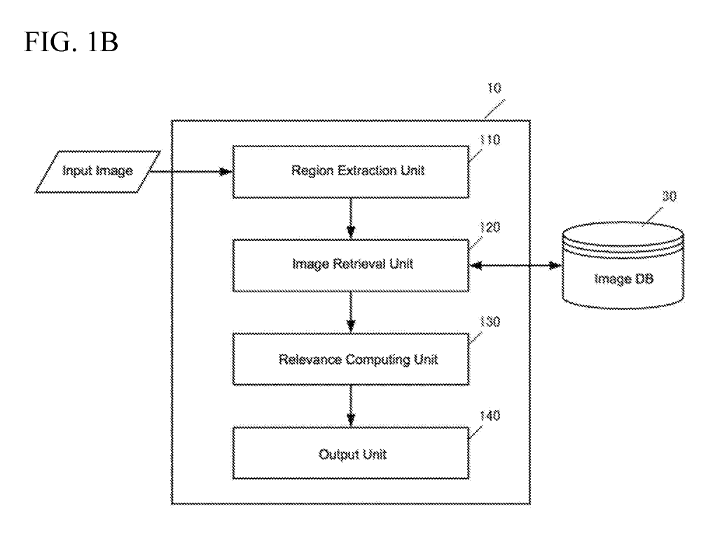

FIG. 1A illustrates the hardware configuration of a region-of-interest extraction device 10 according to a first embodiment. The region-of-interest extraction device 10 includes an image input unit 11, an arithmetic device 12, a storage device 13, a communication device 14, an input device 15, and an output device 16. The image input unit 11 is an interface for acquiring image data from a camera 20. Note that while in this embodiment image data is directly acquired from the camera 20, the image data may be acquired through the communication device 14. The image data may also be acquired via storage media. The arithmetic device 12 is a general-purpose processor such as a central processing unit (CPU) that executes a program stored on the storage device 13 to implement the later described functions. The storage device 13 includes a primary storage device and an auxiliary storage device. In addition to storing the programs executed by the arithmetic device 12, the storage device 13 stores image data and temporary data while programs are being executed. The communication device 14 allows the region-of-interest extraction device 10 to communicate with external computers. The form of communication may be wired or wireless, and may be provided under any desired standard. In this embodiment the region-of-interest extraction device 10 accesses an image database 30 via the communication device 14. The input device 15 may be configured by a keyboard or mouse or the like, and allows the user to enter instructions for the region-of-interest extraction device. The output device 16 may be configured by a display device and a speaker or the like, and allows the region-of-interest extraction device to provide output to the user.

The image database 30 is a computer including an arithmetic device and storage device, and the like, and stores a plurality of image data so the same may be retrieved. The image database 30 may be a single computer or may be configured by multiple computers. Other than the data of the image itself (per pixel color information, for instance), the image data stored in the image database 30 maybe stored in association with various kinds of attribute information. For example, a data file containing the image data may include various kinds of property information attribute information in the Exif format. The image database 30 may also map and store the image data in association with attribute information recorded in a file different from the data file for the image data. Attribute information may include for instance, the size of the image, the color space, the imaging conditions (date taken, shutter speed, stop, ISO sensitivity measurement, metering mode, presence or absence of flash, focal length, imaging position, and the like), a natural language description of the content and features of the image (tag information), and the like. This attribute information is meta-information for the image data. The image database 30 may be generally available via a public network such as the Internet and allow registration and searching of image data.

There are no particular restrictions on who may register an image in the image database 30 or the number of images that can be registered. For instance, an image containing an object a user of the region-of-interest extraction device 10 should focus on may be registered to the database. In this case, it can be said that an image suited for region-of-interest extraction is registered to the image database; therefore, a large quantity of images do not need to be registered. A third party such as an individual user or a search service provider may also register images in the database. However, the registered image may be unsuitable for the region-of-interest extraction process. Therefore, preferably many of the images are already registered in the image database 30.

Functions and Processes in the Region-of-Interest Extraction Device

The arithmetic device 12 may run a program to implement the kind of functions illustrated in FIG. 1B. That is, the arithmetic device 12 provides the functions of a region extraction unit 110, an image retrieval unit 120, a relevance computing unit 130, and an output unit 140. The processing in each of these units is as follows.

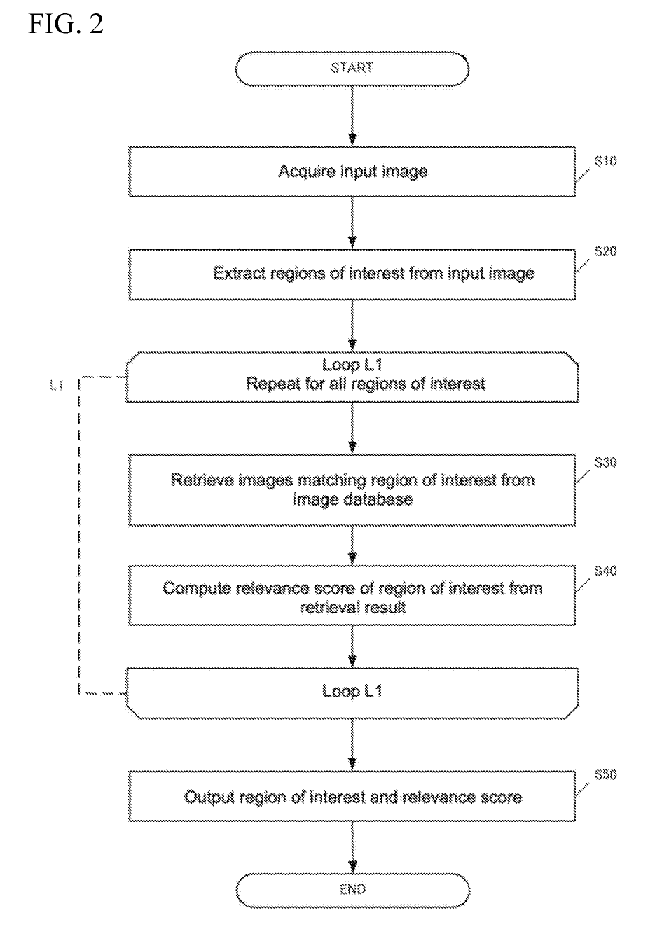

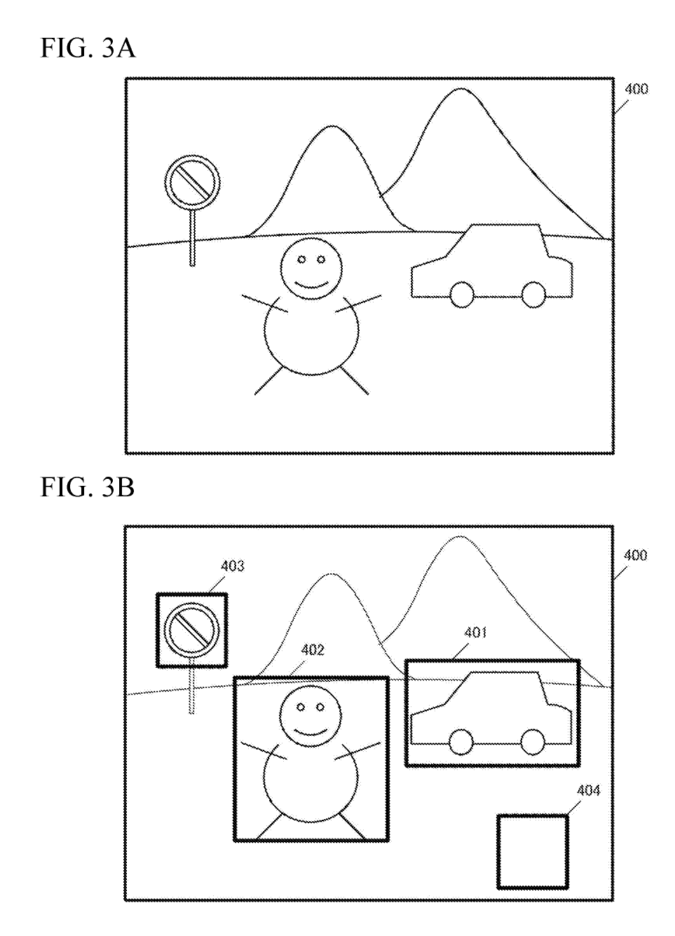

FIG. 2 is a flowchart illustrating processes carried out by the region-of-interest extraction device 10 to extract a region of interest. In step S10 the region-of-interest extraction device 10 acquires an image (an input image). An input image may be obtained from a camera via the image input unit 11, from another computer via the communication device 14, or from storage media via the storage device 13. FIG. 3A depicts one example of an input image 400.

In step S20 the region extraction unit 110 extracts a region of interest (a local region) from the input image. The algorithm that the region extraction unit 110 uses is not particularly limited; any existing algorithm may be adopted including a learning-based algorithm or a model-based algorithm. The region extraction unit 110 is also not limited to a single algorithm and may employ a plurality of algorithms to extract a region of interest. Given that learning-based algorithms can only extract learned objects, it is preferable that a model-based extraction algorithm is used.

FIG. 3B depicts an example of a region of interest extracted from the input image 400. In this example, four regions of interest 401-404 are extracted from the input image 400. The region 401 is a car, the region 402 is a person, and the region 403 is a road sign. While the region 404 is not a region of interest in and of itself, this is a false positive detected by the region extraction unit 110.

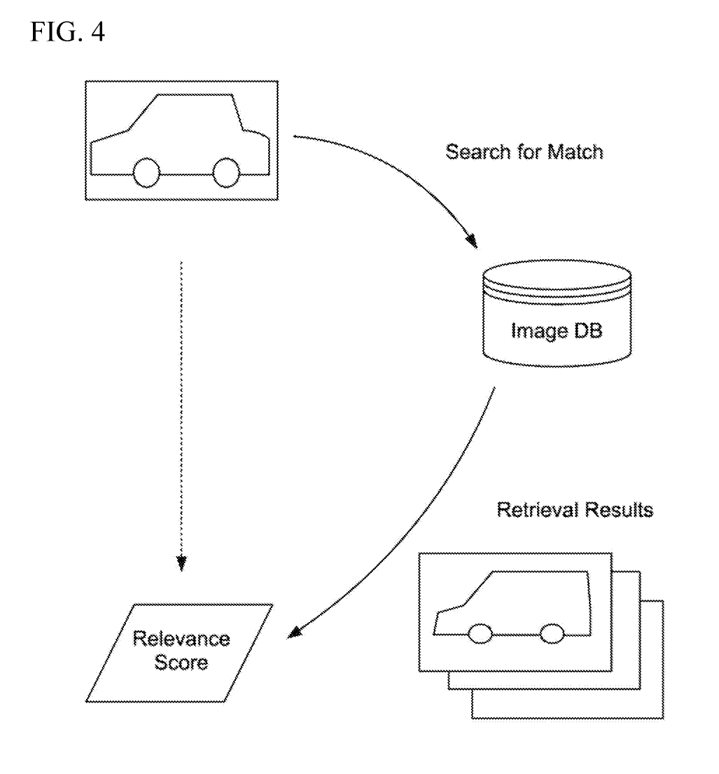

Next, as illustrated in FIG. 4, the image retrieval unit 120 retrieves a similar image and computes the relevance score of the region of interest on the basis of the retrieval result for each of the regions of interest extracted in step S20 (Loop L1). More specifically, the image retrieval unit 120 issues a query to the image database 30 in step S30 to retrieve images matching each region of interest, and acquires the retrieval result from the image database 30. On receiving a search query, the image database 30 retrieves an image from the database matching the search image included in the search query (an image of the region of interest) and transmits the retrieval result. Any known algorithm may be adopted for content-based image retrieval from the image database 30. For example, an algorithm that compares an entire image with another entire image, an algorithm that compares an entire image with a portion of another image, or an algorithm that compares a portion of one image with a portion of another image may be adopted. The image database transmits the similar image obtained through the search and the attribute information for the same to the region-of-interest extraction device 10 as the retrieval result.

In step S40 the relevance computing unit 130 in the region-of-interest extraction device 10 computes the relevance score of the region of interest on the basis of search results obtained from the image database 30. The relevance computing unit 130 in this embodiment computes a plurality of discrete relevance scores (R1-R4) on the basis of the retrieval results, and combines the plurality of discrete relevance scores into a final relevance score R (total relevance score). A discrete relevance score is a relevance score evaluated on different viewpoints: for instance, a relevance score (R1) based on the number of similar images matching the search; a relevance score (R2) based on an average similarity score of the similar image; a relevance score (R3) based on the relative size of the similar region in the similar image; and a relevance score (R4) based on a semantic convergence of the tag information. In this embodiment the discrete relevance scores R1-R4 are normalized numerical values from 0 to 1, and the total relevance score R is a product of the discrete relevance scores R1-R4 (R=R1×R2×R3×R4). However, if the total relevance score is defined on the basis of the discrete relevance scores R1-R4, for example, the total relevance score R may be calculated as an average (including a weighted average), a maximum, a minimum, or the like of the discrete relevance scores R1-R4. The discrete relevance scores described here are merely examples, and the values employed may be defined according to criteria other than the above on the basis of the search parameters. A relevance score does not need to be computed from only the retrieval result; for instance, a relevance score may be computed taking into account the extraction region itself, or the input image.

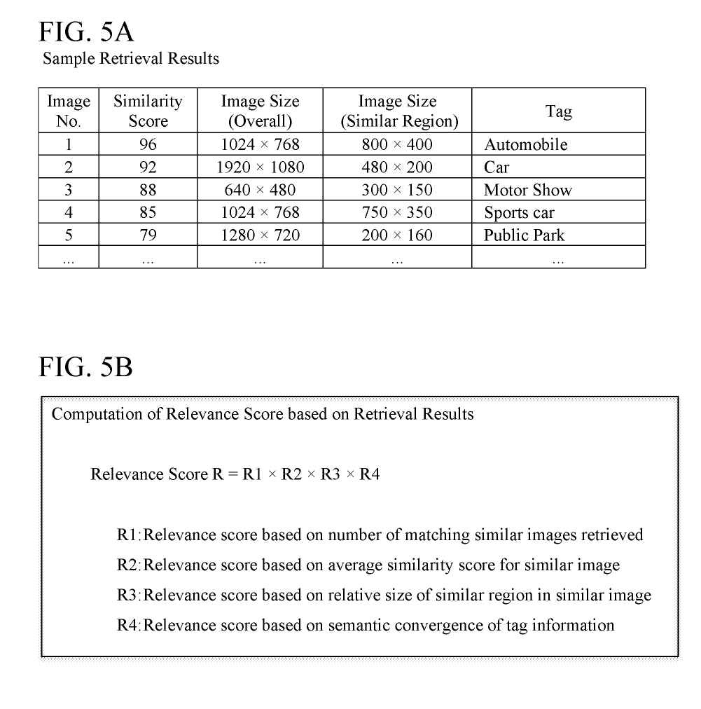

FIG. 5A depicts one example of the retrieval results obtained in step S30. FIG. 5A shows an image number 501, a similarity score 502, an overall size 503 of the similar image, a size 504 of the region in the similar image matching the region of interest, and tag information 505 stored in association with the similar image; however, the retrieval result may include other information.

FIG. 5B illustrates an example of the relevance score computation carried out by the relevance computing unit 130. The relevance score R1, which is based on the number of similar images matching the search, is given a higher score based on the number of search hits. Thus, the more images of the object that are stored in the image database 30, the higher the relevance score is computed. The number of search hits used for computing the relevance score R1 may be all the similar images sent from the image database 30, or the number of similar images in the results that have a similarity score 502 greater than or equal to a predetermined threshold.

The relevance score R2 which is based on an average similarity score of the similar image is given a higher score the higher the average similarity score 502 of the similar images included in the retrieval results. A large quantity of search hits does not necessarily mean that the object is highly relevant, especially if the similar image has a low similarity score. Therefore, considering an average similarity score improves the accuracy of computing the relevance score. Although the average of the similarity score is used for computing the relevance score R2 in this case, any statistic such as the mode, median, variance, or standard deviation may be used for the computation of the relevance score R2.

The relevance score (R3) which is based on the relative size of the similar region to the similar image is given a higher score the larger the average ratio of the size 504 of the similar region to the overall size 503 of the similar image in the retrieval result. Hereby, the larger the object is captured in the image the higher the relevance score is computed. The relevance score R3 may be computed using these values based on criteria other than the ratio of the size 504 of the similar region to the entire overall size 503 of the similar image.

The relevance score R4, which is based on the semantic convergence of the tag information, is given a higher score when there is a higher semantic convergence of the tag information included in the retrieval result. Hereby, the more people who assign tag information that has the same meaning to the object, the higher the relevance score is computed. Semantic convergence is preferably determined through natural language processing, so that even if the wording used in the tag information is different, the semantics should be more likely to converge for identical or neighboring concepts. The relevance computing unit 130 may categorize the semantics of the tag information included in the retrieval result, and calculate a percentage in relation to the overall number of elements in the largest category. In the example of tag information illustrated in FIG. 5B, both “automobile” and “car” would be placed in the same category. Further, given that a “sports car” is a more specific concept relative to “automobile” and “car”, the “sports car” can also be placed in the same category as the “automobile” and the “car”. In contrast, a “park” is a different concept than an “automobile” and is therefore placed in a different category. Note that a “motor show” is a concept related to an “automobile” and the like, and so may be place in the same category, or placed in a different category. In this example, the “motor show” and the “automobile” are in the same category, so that when the retrieval result includes five items as illustrated in FIG. 5B, the relevance computing unit 130 computes the relevance score R4 as 0.8 (i.e., 4/5). Although FIG. 5B provides an example where the tag information are single words, tag information may also be expressed in sentence form, and the semantics thereof may also be estimated based on natural language processing in that case.

The relevance computing unit 130 computes a total relevance score R on the basis of the discrete relevance scores R1-R4 as above described. Here, the above discrete relevance scores R1-R4 are computed with larger values for areas estimated to draw a human's attention. That is, the discrete relevance scores R1-R4 are general purpose relevance scores targeting humans in general, and thus the total relevance score R calculated on the basis thereof can also be considered a general-purpose relevance score.

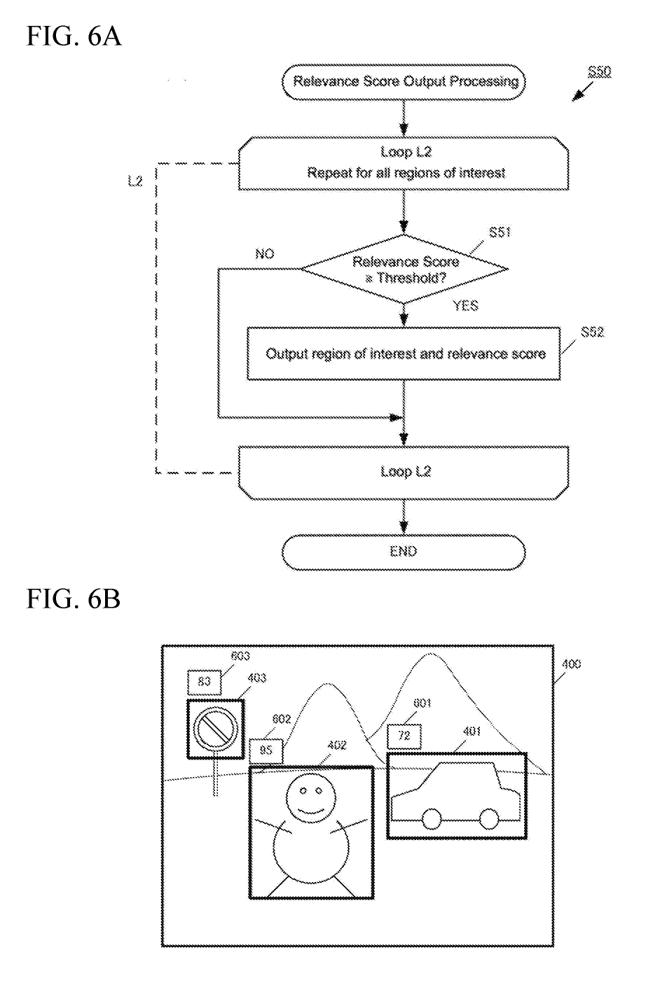

After the relevance scores are computed for all the regions of interest, in step S50 the output unit 140 outputs the locations of the regions of interest in the input image, and the relevance score for each of the regions of interest. The output unit 140 does not output all the regions of interest extracted in step S20, instead, the output unit 140 outputs the regions of interest whose relevance score is greater than or equal to a predetermined threshold ThR. FIG. 6A is a flowchart for describing the output process in step S50 in detail. The output unit 140 carries out the following processes repeatedly for all the regions of interest extracted in step S20 (Loop L2). First, the output unit 140 determines whether or not the relevance score computed for the region of interest is greater than or equal to the threshold ThR (S51). If the relevance score is greater than or equal to the threshold ThR (S51-YES), the output unit outputs the location and relevance score of the aforementioned region of interest (S52); however, if the relevance score is less than the threshold ThR (S51-NO), then the output unit does not output the location or relevance score of the aforementioned region of interest.

FIG. 6B depicts one example of the location and relevance score output for a region of interest in a first embodiment. Here, the regions of interest 401-403 among the regions of interest 401-404 have a relevance score that is greater than or equal to the threshold ThR. Therefore, the regions of interest 401-403 are surrounded by borders to indicate the locations thereof. Relevance score indicators 601-603 are also shown next to the regions of interest 401-403 respectively indicating the numerical values for the relevance score of each of these regions of interest. The region of interest 404 is not shown because the relevance score thereof is less than the threshold ThR. Note that this is merely one example, and for instance, the location of a region of interest may be identified by changing the brightness or color thereof when showing the regions of interest and areas other than the regions of interest. Additionally, the relevance score does not need to be shown numerically; for instance, changing the color or shape of a symbol may indicate the size of relevance score; the size of relevance score may also be indicated by changing the thickness of the border around the region of interest.

While the example described here involves showing the results of extracted regions of interest and the relevance scores therefor on a screen, these results may, for instance, be output on another device or another computer, or output to a storage device (i.e., stored).

Effects of the Embodiment

A first embodiment outputs a region of interest from an input image using information from images stored in an image database, to further improve the accuracy of extraction compared to extracting a region of interest from only the input image. More specifically, compared to existing learning-based techniques for extracting regions of interest, the type of region of interest that can be extracted is not limited to regions similar to the learning data, providing the advantage that various kinds of objects may be extracted as regions of interest. Additionally, using retrieval results from an image database improves the accuracy of extracting regions of interest compared to existing model-based techniques for extracting regions of interest.

### Second Embodiment

A second embodiment is described below. A second embodiment is fundamentally the same as a first embodiment; however, a second embodiments differ in that the regions of interest extracted on the basis of the number of search hits for a similar image are evaluated on whether the region of interest was properly extracted.

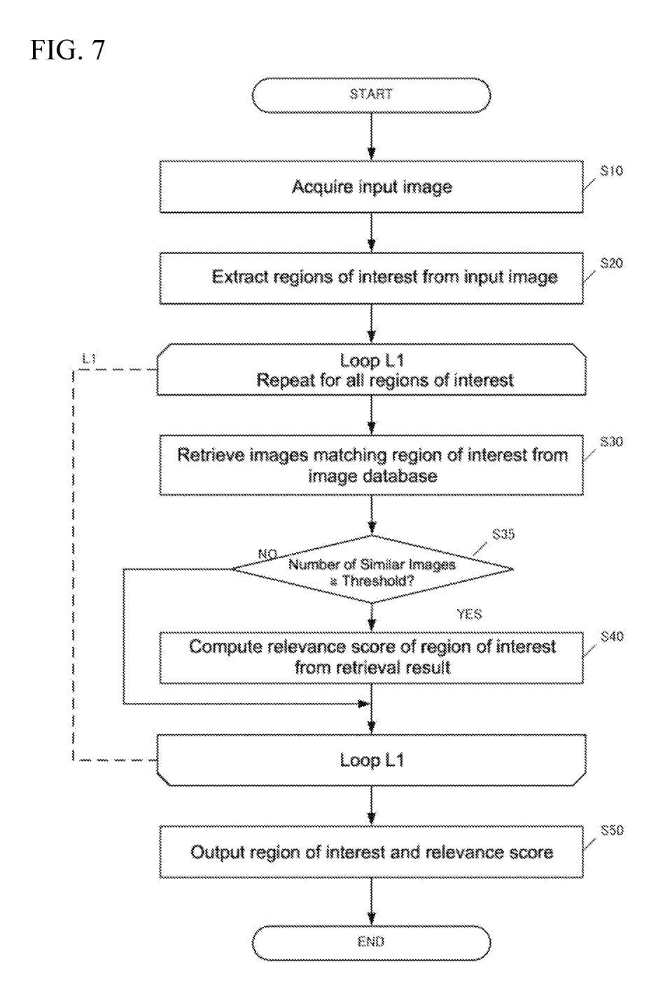

FIG. 7 is a flowchart representing the flow of processes for extracting a region of interest in a second embodiment. Compared to a first embodiment (FIG. 2), a second embodiment adds a process for comparing the number of similar images retrieved to a threshold ThN after the content-based image retrieval step S30. The relevance computing unit 130 computes the relevance score of the region of interest similar to a first embodiment (S40) when the number of similar images retrieved is greater than or equal to the threshold ThN (S35-YES); however, the relevance computing unit 130 does not compute the relevance score of the region of interest when the number of similar images retrieved is less than the threshold ThN (S35-NO).

Thus, regions where only a few similar images are retrieved do not have the relevance score computed therefor. Regions with only a few similar images may be considered not important enough to require attention, and thus the above evaluation process may also be considered as a process for determining whether the accuracy of the region-of-interest extraction process in step S20 is at or above a given threshold.

This extraction accuracy does not need to be evaluated in accordance with the number of search hits for similar images, and the evaluation may be carried out based on other criteria. It may also be understood that in this embodiment, the extraction accuracy and the relevance score for a region extracted by the previously described region-of-interest extraction process (S20) are each computed on different criteria using the results of content-based image retrieval.

### Third Embodiment

A third embodiment is described below. In the above mentioned first and second embodiments, the relevance score is computed as a general-purpose linear measure for humans in general. However, if the region-of-interest extraction process is for a specific user or application, then the relevance score computed should be made user- or application-specific based on prior knowledge. A region-of-interest extraction device 310 according to a third embodiment accepts a relevance score computation parameter selected on the basis of prior knowledge to also obtain a user-specific relevance score.

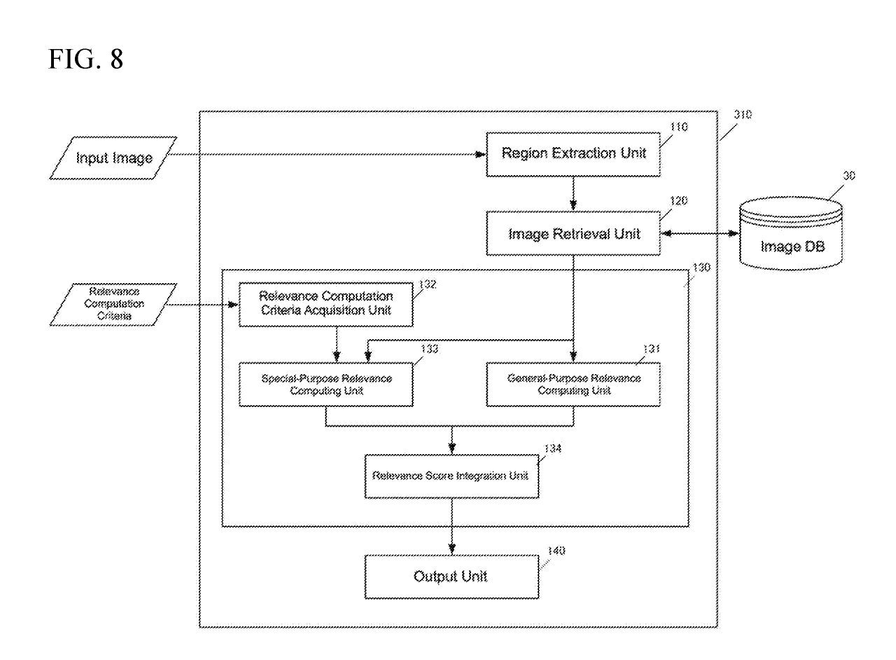

The hardware configuration of the region-of-interest extraction device 310 according to this embodiment is identical to the hardware configuration of a first embodiment (FIG. 1A). The arithmetic device 12 in the region-of-interest extraction device 310 executes a program to implement the function blocks illustrated in FIG. 8. While the function blocks in the region-of-interest extraction device 310 are basically identical to the function blocks in a first embodiment (FIG. 1B), the relevance computing unit 130 includes a general-purpose relevance computing unit 131, a relevance score computation criteria acquisition unit 132, a special-purpose relevance computing unit 133, and a relevance score integration unit 134.

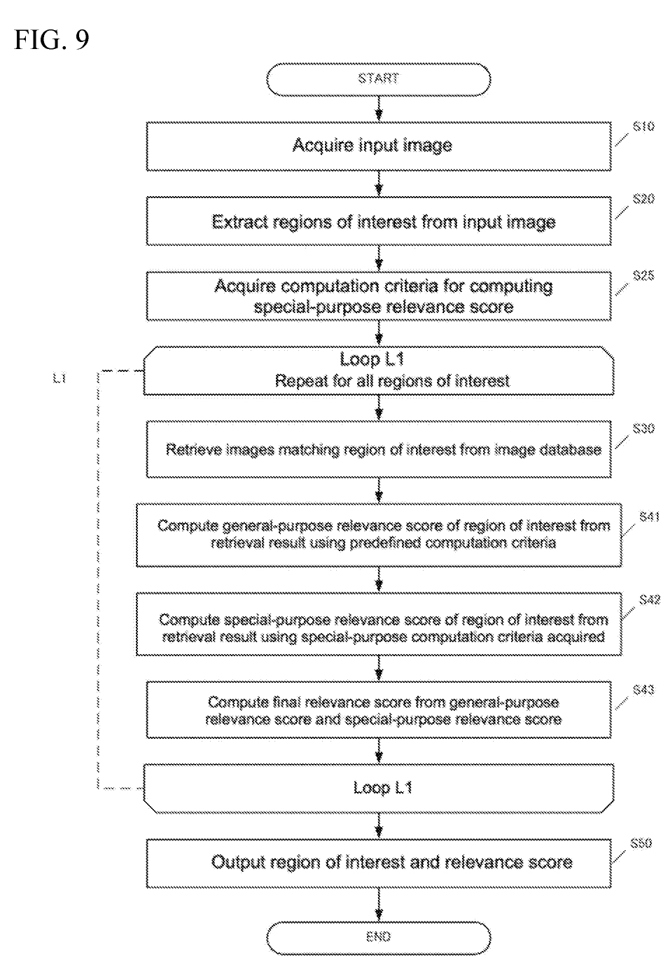

FIG. 9 is a flowchart illustrating processes carried out by the region-of-interest extraction device 310 for extracting a region of interest. The processes identical to processes in a first embodiment (FIG. 2) are given the same reference numerals and a description therefor is not repeated.

In step S25, the relevance score computation criteria acquisition unit 132 acquires the criteria used to compute the user- or application-specific relevance score (special-purpose relevance score). The computation criteria change in accordance with the user or application that will use the processing results from the region-of-interest extraction device 310. For instance, if there is prior knowledge that a given user has a particular interest in a certain object, the relevance score of said object should be computed as a larger value for this user. Additionally, the relevance score of the object should be computed as a larger value in cases where an application should warn a user about an object that tends to be overlooked, since the object may be small in the input image, or may be a color that blends with the surroundings, making the object hard to notice. The relevance score computation criteria acquisition unit 132 may accept the computation criteria itself from an external source, or acquire information specifying the user or the application, or acquire the relevance score computation criteria itself that corresponds to the user or the application. In the latter case, the relevance score computation criteria acquisition unit 132 may store the relevance score computation criteria per user or per application, or sending a request to an external device to obtain the relevance score computation criteria. Note that in FIG. 9 the relevance score computation criteria is acquired after step S20, however, the relevance score computation criteria may be obtained before the input image is acquired in S10 or before the region-of-interest extraction process in S20.

The relevance computing unit 130 computes a relevance score for each of the regions of interest extracted from the input image during the loop L1 similar to a first embodiment. The specific method of computation in this embodiment differs from a first embodiment and is therefore described below.

The image retrieval unit 120 issues a query to the image database 30 in step S30 to retrieve images matching the regions of interest, and acquires the retrieval result from the image database 30. This process is the same as the process in a first embodiment. The general-purpose relevance computing unit 131 computes a general-purpose relevance score in step S41 using the retrieval results and a predetermined computation criteria. This process is the same as the relevance computing process in a first embodiment (S40).

Next, the special-purpose relevance computing unit 133 computes a user- or application-specific relevance score (special-purpose relevance score) in step S42 using the retrieval result from the image retrieval unit 120 and the computation criteria acquired from the relevance score computation criteria acquisition unit 132. Except for the computation criteria, this process is the same as the process in the general-purpose relevance computing unit 131. Note that special-purpose relevance computing unit 133 computes a plurality of discrete relevance scores according to different criteria, and computes a special-purpose relevance score by combining the plurality of discrete relevance scores.

The relevance score integration unit 134 combines the general-purpose relevance score computed by the general-purpose relevance computing unit 131 and the special-purpose relevance score computed by the special-purpose relevance computing unit 133 into a final relevance score. Any desired method may be used to combine the relevance score; for instance, the final relevance score may be an average of the general-purpose relevance score and the special-purpose relevance score (a simple average or a weighted average). The weight for the weighted average may be fixed, or may change in accordance with the user or application. Additionally, the relevance score integration unit 134 may use a weighted average of the individual relevance scores computed when computing the general-purpose relevance score and the special-purpose relevance score, or may select a function of the individual relevance scores as the final relevance score.

The output process that takes place after the relevance score for each of the regions of interest is computed (S50) is the same as a process in a first embodiment.

An example of a computation criteria for a special-purpose relevance score is described below. As above described, the relevance score may be computed as a larger value the greater the interest a user may have using a pattern of interest for the user. Additionally, when a user has trouble perceiving a specific color, the relevance score for objects including this color may be computed as larger values. Further, if the application is for detecting objects that are harder to notice, the relevance score of such an object may be computed as a larger value the smaller the size of the region of interest in the input image. Finally, when region-of-interest extraction method is applied to video, the relevance score may be computed as a larger value for objects suddenly appearing in the video (i.e., objects that were not present in the previous frame), or in contrast the relevance score may be computed as a larger value for objects that continuously present for a long time.

This embodiment computes a general-purpose relevance score and a relevance score specific to the chapter's specific purpose, combines the relevance score into a final relevance score. Therefore, a third embodiment is capable of computing a purpose-based relevance score.

Note that both the general-purpose relevance score and the special-purpose relevance score are not required, and an embodiment may obtain only the special-purpose relevance score. In this case, the general-purpose relevance computing unit 131 and the relevance score integration unit 134 may be excluded from the relevance computing unit 130.

### Fourth Embodiment

A fourth embodiment is described below. The process of outputting a region of interest differs from the processes in first through third embodiments. More specifically, mutually adjacent regions of interest in the input image are combined and output as a single region of interest.

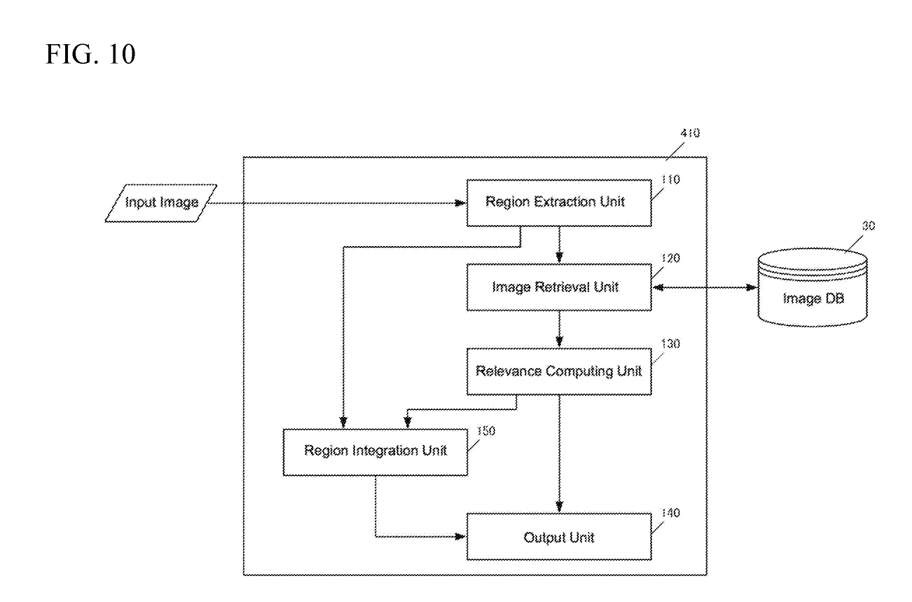

The hardware configuration of a region-of-interest extraction device 410 according to this embodiment is identical to the hardware configuration of a first embodiment (FIG. 1A). The arithmetic device 12 in the region-of-interest extraction device 410 executes a program to implement the function blocks illustrated in FIG. 10. In addition to the functions in a first embodiment, the region-of-interest extraction device 410 is provided with a region integration unit 150.

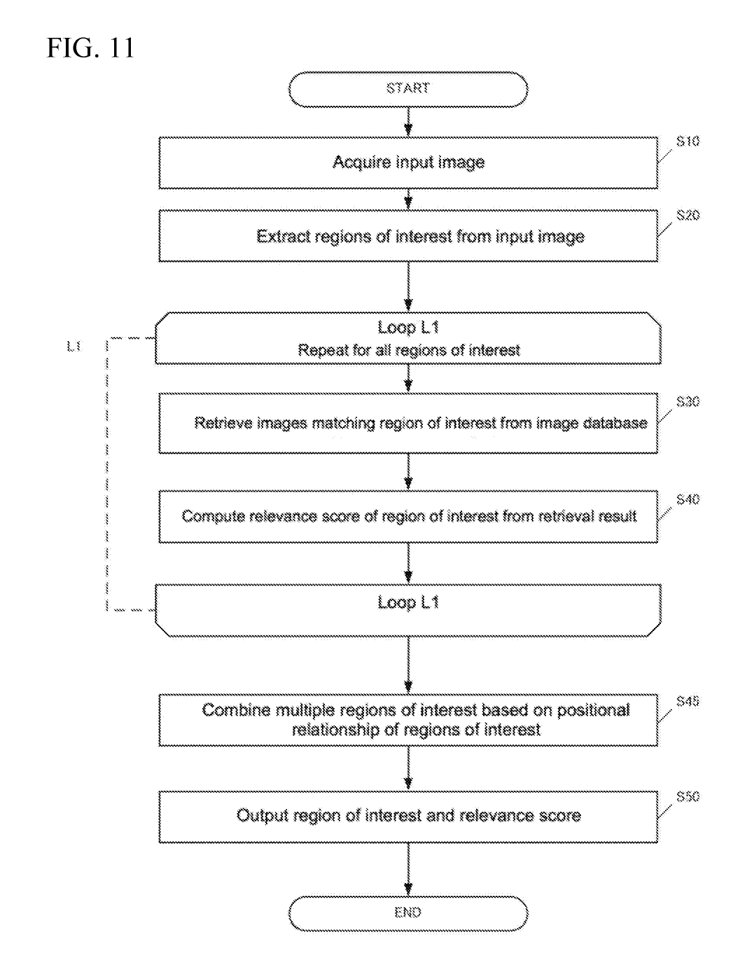

FIG. 11 is a flowchart illustrating the processes carried out by the region-of-interest extraction device 410 for extracting a region of interest. The processes identical to processes in a first embodiment (FIG. 2) are given the same reference numerals and a description therefor is not repeated. In a fourth embodiment, after the processing in Loop L1, the region integration unit 150 combines a plurality of regions of interest on the basis of the positional relationship between the regions of interest in step S45. For example, the region integration unit 150 combines regions of interest if the distance between the regions of interest are less than or equal to a predetermined threshold ThD. The distance between regions of interest may be defined as the distance between centers (number of pixels), or the distance between borders. The above-mentioned threshold ThD may be a fixed value, or may change in accordance with the size of the region of interest or the kind of object within the region of interest.

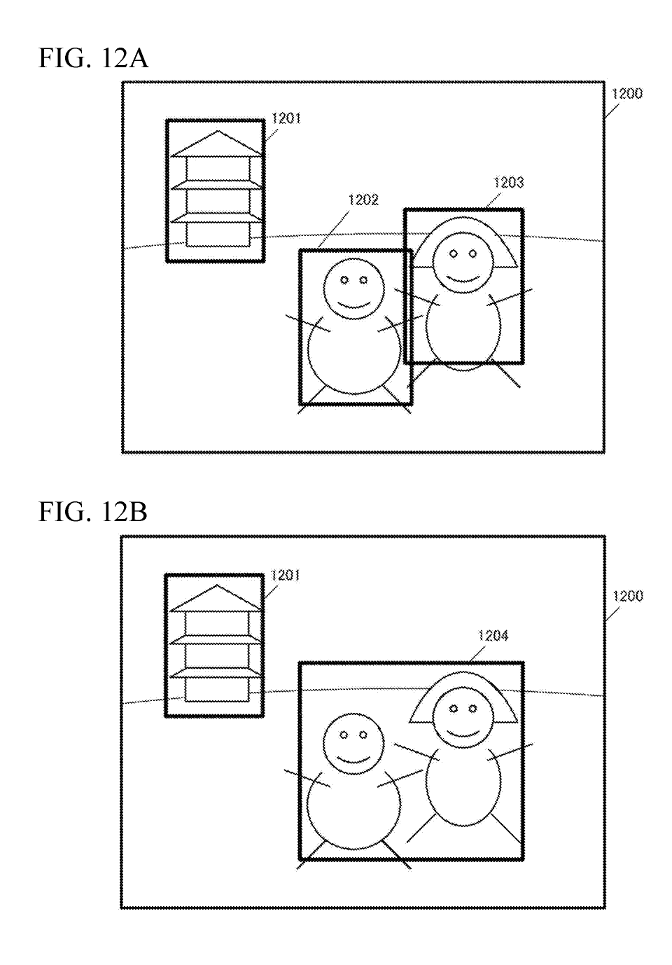

FIG. 12A depicts regions of interest 1201-1203 extracted from an input image 1200 in step S20. While the region of interest 1201 is distant from other regions of interest, the region of interest 1202 and the region of interest 1203 are close to each other. Therefore, the region integration unit 150 combines the region of interest 1202 and the region of interest 1203. FIG. 12B illustrates the image 1200 after the integration process. As illustrated, the region of interest 1202 and the region of interest 1203 are combined into a single region of interest 1204. Note that after the combination the region of interest 1204 is the smallest square that includes the region of interest 1202 and the region of interest 1203, however, the combined region of interest 1204 may be generated through different techniques.

During the region integration process, the regions of interest with a low relevance score may be excluded from integration, or the integration performed only for regions of interest where the relevance scores thereof satisfy a predetermined relationship (e.g., the average relevance score is greater than or equal to a given threshold). That is, the relevant integration unit 150 may determine whether or not to combine regions of interest on the basis of the relevance score of the region of interest and the distance between the regions of interest. The region integration unit 150 may also combine three or more regions of interest into a single region of interest.

The region integration unit 150 also determines the relevance score for a combined region of interest when a plurality of regions of interest is combined. While it is preferably for the relevance score of a combined region of interest to be, for instance, the mean, maximum, or the like of the relevance scores, the relevance score of the combined region of interest may be determined by some other method.

Except for using a combined region of interest, the relevance score output process for a region of interest in step S50 is the same as the process in a first embodiment.

A fourth embodiment combines a plurality of regions of interest that are in a mutually close relationship to minimize the number of regions of interest output. Additionally, adopting a relevance score that uses the retrieval results from an image database when determining whether or not to combine regions allows more suitable combination of the regions.

### Other Embodiments

The embodiments described above are provided merely as examples, and the invention is not limited to the specific example above described. The invention may be modified in various ways within the scope of the technical ideas therein.

In the above description, the image database and the region-of-interest extraction device are on different devices; however, the image database and the region-of-interest extraction device may be configured as a single device. The image data included in the image database may also be registered by the manufacturer of the region-of-interest extraction device or by user. The region-of-interest extraction device may employ a plurality of image databases including an image database built into the device, and an image database on an external device.

The method of computing the relevance score is provided as an example in the above description; the method of computation in one or more embodiments is not particularly limited as long as the relevance score is computed using retrieval results from searching for an image that matches the region of interest. A relevance score is preferably computed using statistical information from the retrieval result. This statistical information from the retrieval result includes number of search hits, a statistical value for a similarity score, a statistical value for the size of the similar image, the position within the similar image of a region matching the search image, and a convergence of the meaning expressed by the tag information. When the similar image includes meta information, the relevance score may be computed on the basis of a statistical value for the meta information. Note that, a statistical value is a value obtained by performing statistical processing on a plurality of data and for example includes the mean, median, median, variance, standard deviation, or the like.

The relevance score of the region of interest may be computed using information other than the results of content-based image retrieval. For instance, the relevance score may be computed on the basis of the size or color of the region of interest itself, or the location of the region of interest within the input image or the like.

The above description assumes that the input image is a still image; however the input image may be a video (a plurality of still images). In this case, the region extraction unit 110 may use existing algorithms for extracting a region of interest from the video when extracting a region of interest. Additionally, the relevance computing unit 130 may compute the relevance score keeping in mind the change of position of the region of interest over time. For example, the speed, movement direction, and the like of the region of interest may be taken into account. The relevance score of the region of interest may be computed as larger or smaller the faster the region of interest moves. Furthermore, when computing the relevance score of the region of interest by taking into account the movement direction, the relevance score may be computed on the basis of the movement direction itself, or the relevance score may be computed on the basis of the variation in the movement direction.

A region-of-interest extraction device according to one or more embodiments may be packaged in any information processing device (i.e., computer) such as a desktop computer, a portable computer, a tablet computer, a smartphone, a mobile phone, a digital camera, or a digital video camera.

### REFERENCE NUMERALS

10, 310, 410: Region-of-interest extraction device
20: Camera, 30: Image database,
110: Region extraction unit, 120: Image retrieval unit 130: Relevance Computing Unit
140: Output unit 150: Region integration unit
400: Input image 401,402,403,404: Region of interest
601, 602, 603: Relevance score indicator
1200: Input Image
1201, 1202, 1203: Regions of interest (prior to combination)
1204: Regions of interest (after combination)

1. A region-of-interest extraction device comprising: an extraction unit configured to extract one or a plurality of local regions from an input image;
a retrieval unit configured to search an image database storing a plurality of images and retrieve an image matching a local region for each of the local regions extracted by the extraction unit; and
a relevance score determination unit configured to determine a relevance score for each of the local regions on the basis of the retrieval result from the retrieval unit.

2. The region-of-interest extraction device according to claim 1, wherein the relevance score determination unit determines a relevance score of a local region using statistical information of an image retrieved by the retrieval unit as matching the local region.

3. The region-of-interest extraction device according to claim 1, wherein the relevance score determination unit determines a higher relevance score for a local region the larger the number of images that match the local region.

4. The region-of-interest extraction device according to claim 3, wherein the relevance score determination unit does not determine the relevance score for a local region whose number of similar images retrieved is less than a threshold.

5. The region-of-interest extraction device according to claim 1, wherein the relevance score determination unit determines a higher relevance score for a local region the greater the semantic convergence of tag information associated with the similar images matching the local region.

6. The region-of-interest extraction device according to claim 1, wherein the relevance score determination unit determines the relevance score for a local region on the basis of the size or location of the local region.

7. The region-of-interest extraction device according to claim 1, further comprising: a computation criteria acquisition unit configured to accept input of criteria for computing relevance score; and
the relevance score determination unit computes the relevance score on the basis of a first relevance score computed according to a predetermined computation criteria, and a second relevance score computed according to a computation criteria acquired through the computation criteria acquisition unit.

8. The region-of-interest extraction device according to claim 1, further comprising: an integration unit configured to combine a plurality of neighboring local regions in the input image into a single local region.

9. The region-of-interest extraction device according to claim 1, further comprising: an output unit configured to output the location of the local regions included in the input image and the relevance score for each of the local regions.

10. The region-of-interest extraction device according to claim 9, wherein the output unit is configured to output the location and relevance score for only a local region whose relevance score is greater than or equal to a threshold.

11. A region-of-interest extraction method carried out on a computer, the region-of-interest extraction method comprising:
extracting one or a plurality of local regions from an input image;
searching an image database storing a plurality of images and retrieving an image matching a local region for each of the local regions extracted from the input image; and
determining a relevance score for each of the local regions on the basis of the retrieved image.

12. A non-transitory computer-readable recording medium storing a program causing a computer to perform operations comprising a method according to claim 11.
